(19) United States
(12) Patent Application Publication
(10) Pub. No.: US 2013/0187795 A1
(43) Pub. Date: Jul. 25, 2013

(54) SYSTEM AND METHOD FOR NOTIFICATION OF PARKING-RELATED INFORMATION

(71) Applicant: Daniel C. Lowenthal, Santa Rosa, CA (US)

(72) Inventor: Daniel C. Lowenthal, Santa Rosa, CA (US)

(21) Appl. No.: 13/780,336

(22) Filed: Feb. 28, 2013

Related U.S. Application Data
(63) Continuation of application No. 12/961,825, filed on Dec. 7, 2010, now abandoned.
(60) Provisional application No. 61/288,245, filed on Dec. 18, 2009.

(51) Int. Cl. G08G 1/127

(52) U.S. Cl. CPC G08G 1/127
USPC 340/989

(57) ABSTRACT

Devices, systems and methods for notifying vehicle owners of parking-related conditions are described. Particularly, devices, systems, and methods for identifying and presenting at the appropriate time relevant parking information to an owner are disclosed. Present embodiments can accomplish this presentation using a common handheld device, providing an easy and accessible means for identifying relevant parking information.

### CROSS REFERENCE RELATED APPLICATIONS

This application claims priority to and is a continuation of U.S. application Ser. No. 12/961,825, filed on Dec. 7, 2010, entitled SYSTEM AND METHOD FOR NOTIFICATION OF PARKING-RELATED INFORMATION, which claims priority to U.S. Provisional Patent Application No. 61/288,245, filed Dec. 18, 2009, entitled SYSTEM AND METHOD FOR NOTIFICATION OF PARKING-RELATED INFORMATION (attorney reference DLOWE.001PR), which are hereby incorporated herein by reference in their entirety. Any and all priority claims identified in the Application Data Sheet, or any correction thereto, are hereby incorporated by reference under 37 CFR 1.57.

### BACKGROUND

1. Field

Present embodiments relate to notification of parking-related factors and conditions.

2. Description of the Related Art

A parked vehicle is subject to a number of municipal and federal ordinances, as well as environmental conditions of which the vehicle owner may not always be adequately apprised. Particularly when travelling in unfamiliar areas, owners are typically susceptible to overlooking ordinances and conditions which local residents and officials may consider common. For example, certain areas may have a history of high crime, or be subject to temporary construction zoning requirements. These regulations may present complicated, time-dependent constraints on where a user may park.

### SUMMARY OF THE INVENTION

The devices, systems and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description,” one will understand how the features of the devices, systems and methods disclosed herein provide advantages over other known devices, systems and methods.

Present embodiments relate to devices, systems and methods related to notification of parking-related factors and conditions. In some embodiments, a computer implemented system for parking notification executed on at least one processor is provided. The system may include, for example, a positioning module that may include position coordinates and a handheld notification module configured to alert the user upon satisfaction of at least one condition. At least one of the positioning module and the handheld notification module may be configured to receive parking information from a database (datasource).

Certain embodiments contemplate that the positioning module comprises a lightweight beacon which may be located in a vehicle and may be powered by the vehicle's battery.

In some embodiments, the position coordinates can be derived from at least one of a Global Positioning System (GPS), encoders in the vehicle, being manually input by the user, and the like.

In other embodiments the database can be located, for example, in at least one of the handheld device, the positioning module, and the like.

In certain embodiments, the database can be located on a remote server, for example.

In some embodiments the handheld module may consult the database via a wireless protocol to determine a condition's satisfaction, for example.

In certain embodiments the positioning module can notify the handheld module of a condition's satisfaction.

Certain embodiments contemplate the parking information including, for example, the frequency of crime within a range of the position coordinates.

In some embodiments the parking information can include, for example, the ordinances governing parking at the position coordinates.

In some embodiments the condition may include, for example, the time before a parking permit expires.

In some embodiments the handheld module may be configured, for example, to receive the amount of money provided to a parking meter, and the condition may include, for example, the time remaining until expiration based on said amount.

In some embodiments the positioning module can be located within the handheld notification module.

In some embodiments the user can notify the notification module of the parking location. In such embodiments, the notification module can receive a user generated notification of the parking location.

In some embodiments the handheld module can include, for example, a cellular phone.

In certain embodiments the beacon may be located, for example, in the dashboard of the vehicle.

In certain embodiments the beacon can be powered, for example, by the vehicle's cigarette lighter.

Certain embodiments contemplate a computer implemented system for parking notification executed on at least one processor, the system comprising a positioning module configured to determine position coordinates. The system may also comprise a handheld notification module configured to alert the user upon satisfaction of at least one condition. In some embodiments at least one of the positioning module and the handheld notification module may be configured to receive parking information from a database. In some embodiments, the positioning module comprises part of a beacon. In some embodiments, the beacon may be located in a vehicle. In some embodiments, the beacon may be powered by the vehicle's battery. In some embodiments, the positioning module and handheld notification module may comprise parts of a handheld device. In some embodiments, the position coordinates may be derived from at least one of a GPS system, an encoder in the vehicle, and a manual input by a user. In some embodiments, the database may be located on the same device as at least one of the handheld notification module and the positioning module. In some embodiments, the database may be located on a remote server. In some embodiments, the handheld module may communicate with the database via a wireless protocol to determine a condition's satisfaction. In some embodiments, position coordinates determined from the positioning module are used to notify the handheld module of a condition's satisfaction. In some embodiments, the parking information may comprise the frequency of crime within a range of the position coordinates. In some embodiments, the condition may comprise the time remaining on at least one of a parking permit or a parking meter. In some embodiments, the handheld module is configured to receive the amount of money provided to a parking meter, and the condition comprises the time remaining until expiration based on the amount. In some embodiments, the positioning module may be located within the handheld notification module. In some embodiments, the notification module may receive a user notification of the parking location. In some embodiments, the handheld module may comprise part of a cellular phone.

Certain embodiments contemplate a computer implemented system for parking notification executed on at least one processor, the system comprising means for determining a position comprising position coordinates. In some embodiments, the system may comprise means for handheld notification configured to alert a user upon satisfaction of at least one condition, said handheld notification means comprising a visual display depicting a map of the vehicle's present location and one or more relevant ordinances. In some embodiments, at least one of said determining a position means and said handheld notification means may be configured to receive parking information from a database relevant to said position coordinates. In some embodiments, the determining a position means comprises a positioning module and the handheld notification means comprises a handheld notification module.

Certain embodiments contemplate a non-transitory computer-readable medium comprising instructions configured to cause a computer to perform the steps of: record a vehicle position in a position location module; select a plurality of conditions; monitor the plurality of conditions via a handheld device with reference to the positioning module and to a database of ordinances; notify the user of the handheld device upon satisfaction of one or more of the plurality of conditions, via at least one of visual or auditory indicia. In some embodiments, the plurality of conditions of interest may be selected via the handheld device. In some embodiments, recording the vehicle position may comprise generating a timestamp, said timestamp subsequently used in the determination of at least one of the plurality of conditions' satisfaction.

Certain embodiments contemplate a method for providing information associated with a parked vehicle, performed on one or more computer processors, comprising: determining a vehicle's location; communicating the location via a wireless device to a database on a remote server; and receiving parking information from the database associated with the location. In certain embodiments determining a vehicle's location may comprise waiting for the vehicle's engine to be stopped.

Some embodiments relate to a computer implemented system for parking notification executed on at least one processor. Modules, as referred to herein, may comprise any one of software, firmware, hardware components, or combinations thereof. The system may include, for example, a positioning module, which itself may include, for example, position coordinates as well as a handheld notification module configured to alert the user upon satisfaction of at least one condition. The module can include, for example, a visual display depicting a map of the vehicle's present location and one or more relevant ordinances. At least one of said positioning module and said handheld notification module can be configured to receive parking information from a database relevant to said position coordinates.

Certain embodiments relate to a computer implemented parking notification method executed by program instructions on a computer system that may include one or more computing devices. The method may involve, for example, recording a vehicle position using a positioning module upon parking, selecting a plurality of conditions of interest via a handheld device, and monitoring the plurality of conditions via the handheld device with reference to the positioning module and to a database of ordinances. The instructions may then notify the user of the handheld device upon satisfaction of one or more of the plurality of conditions, via at least one of visual or auditory indicia. In some embodiments, a timestamp may be generated at the time of parking and subsequently used in the determination of a condition's satisfaction.

In some embodiments, the condition may include the elapsed time at a given parking location.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout. Understanding that these drawings depict only several embodiments in accordance with the disclosure and are not to be considered limiting of its scope, the disclosure will be described with additional specificity and detail through use of the accompanying drawings:

FIG. 1 is a top-level block diagram of an example architecture for identifying relevant parking information and notifying a handheld unit according to some embodiments.

FIG. 2 is a top-level block diagram of an example architecture for identifying relevant parking information and notifying a handheld unit, wherein the handheld unit serves as the location beacon according to some embodiments.

FIG. 3 is a top-level block diagram of an example of some embodiments' architecture for identifying relevant parking information and notifying a handheld unit wherein the database is stored locally to the handheld.

FIG. 4 is a top-level block diagram of an example of certain embodiments' architecture for identifying relevant parking information and notifying a handheld unit wherein the database is stored locally to the handheld, and the handheld serves as the beacon.

FIG. 5 is a schematic diagram of an example of a communication mechanism available to a hybrid positioning system.

FIG. 6 is a schematic diagram of one example of a layout for depicting parking-related suggestions.

FIG. 7 is a schematic diagram of one example of a handheld device and the user interface of one possible embodiment.

FIG. 8 is a flow diagram of one example of an embodiment of the system's operation.

While, for the purpose of simplicity of explanation, the methodologies shown in the various Figures are shown and described as a series of acts, it is to be understood and appreciated that the present technology is not limited by the order of acts, as some acts may, in accordance with the present technology, occur in different orders and/or concurrently with other acts from that shown and described herein. Likewise, the depicted devices and systems are not limited by the order or particular combination of the components or parts, as some components or parts, in accordance with the present technology, may, for example, be combined in a different order, be included or excluded, or include one or more additional components.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Vehicle users may benefit from receiving information and conditions associated with their parking location. For example, a system with knowledge of a vehicle's location and characteristics of the user, may provide the user with advice, tips and location specific information pertinent to the vehicle's particular position. An intuitive and readily accessible device, system or methodology for apprising the vehicle owner of these conditions has been lacking. In some circumstances, unless vehicle owners receive the information at the appropriate time, they are unlikely to take meaningful action. This information need not only be limited to ordinance related information, but may include, for example, tips and suggestions relevant to the present location of the vehicle. Accordingly, some embodiments relate to devices, systems and methods for notifying users of the relevant parking-related conditions and information at a suitable time. In some aspects these systems may take further advantage of positioning systems, including for example hybrid positioning systems, which can provide more reliable positioning information based on a plurality of positioning resources.

Additionally, vehicle owners may benefit from general advice regarding their parking location. Systems which have knowledge of a vehicle's location, and characteristics of the user, may inform the user of tips and habits pertinent to the vehicle's particular position.

An intuitive and readily accessible system, device and means for apprising the vehicle user of these conditions has been lacking. Unless vehicle users receive the information at the appropriate time, they are unlikely to take meaningful action. This information need not only be limited to ordinance related information, but may comprise tips and suggestions relevant to their present location. Accordingly, present embodiments consider systems for notifying users of the relevant parking-related conditions at a suitable time. These systems may take further advantage of positioning systems. The positioning systems may include for example, hybrid positioning systems, which provide more reliable positioning information based on a plurality of positioning resources.

Present embodiments relate to devices, systems and methods for notifying a vehicle owner of parking-related information in a timely and accessible manner.

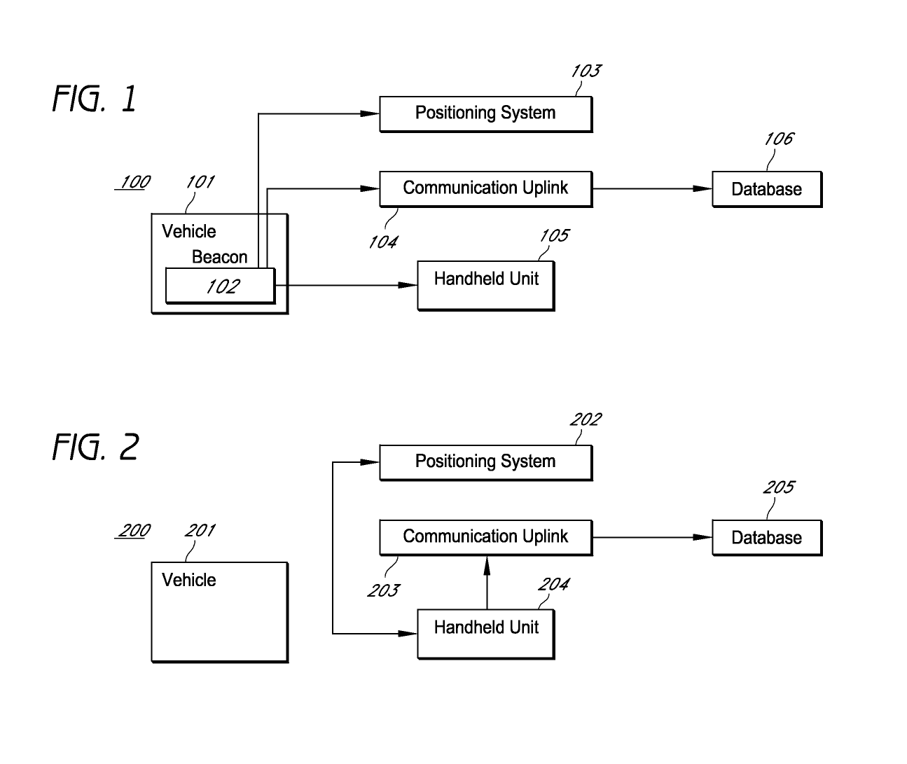

FIG. 1 is a top-level block diagram of certain embodiments' architecture for identifying relevant parking information and notifying a device such as, for example, a handheld unit. System 100 may include a beacon 102 that is within a vehicle 101 (parked or moving), a positioning system 103, a communication uplink 104, a handheld unit 105, and a database 106. In some embodiments the positioning system 103 may include, for example, a hybrid positioning system (HPS). In certain embodiments, the beacon may comprise an electronic device capable of generating wireless transmissions. The beacon may comprise a third party device, such as a personal data assistant, mobile phone, or personal computer, modified to perform the functions described herein. Alternatively, the beacon may comprise an electronic device manufactured specifically for interfacing with the handheld unit and positioning system. The communication uplink may comprise any suitable wireless communication protocol, for example, WIFI, mobile telephone transmissions, Bluetooth, and so forth. The handheld unit may comprise a mobile electronic device carried by the user, but may also comprise devices which are not strictly “held in the hand”, such as laptops, desktop computers, etc. Database 106 may include, for example, a collection of parking-related information stored in a schema suitable for describing various contexts. For example, database 106 may include ordinance related information, such as street-cleaning hours, restricted parking zones, handicap-accessible locations and fine information. The database 106 may also include, for example, a history of crime-related activity for a particular area, a history of construction activity, etc. In some embodiments the database may take the form of an SQL database. In some embodiments, the database may include a plurality of databases, such as web databases of user generated comments, city or municipality databases, etc.

Handheld unit 105 may be a unit specifically designed for parking information notification, but in many embodiments can include, for example, a general purpose device, such as a cellular phone, PDA, or mobile handset. For example, cellular phones may include popular models such as the IPhone, Blackberry, Android, etc. Non-handheld devices, such as laptops, personal computers, or minicomputers, may also be used though they are not strictly “hand held.” The devices may comprise only electronic circuits or may run any suitable operating system. For example, some embodiments contemplate implementations on devices running operating systems such as Symbian, Windows (Mobile, CE, XP and Vista), Mac OS X, or Linux.

In certain embodiments, such as depicted in FIG. 1, a beacon 102, is located with the vehicle 101 to identify parking-related information germane to the vehicle's 101 present location. The beacon may include, for example, an electronic device, powered by the vehicle's internal battery or other power outputs. In other embodiments, the beacon 102 can be integrated into the vehicle 101, for example, into the dashboard, in the same manner as an internal radio or gps system would be. Regardless of the particular form it takes within the vehicle, the beacon can serve a dual purpose: 1) retrieving parking related information and potentially 2) notifying the handheld of this information.

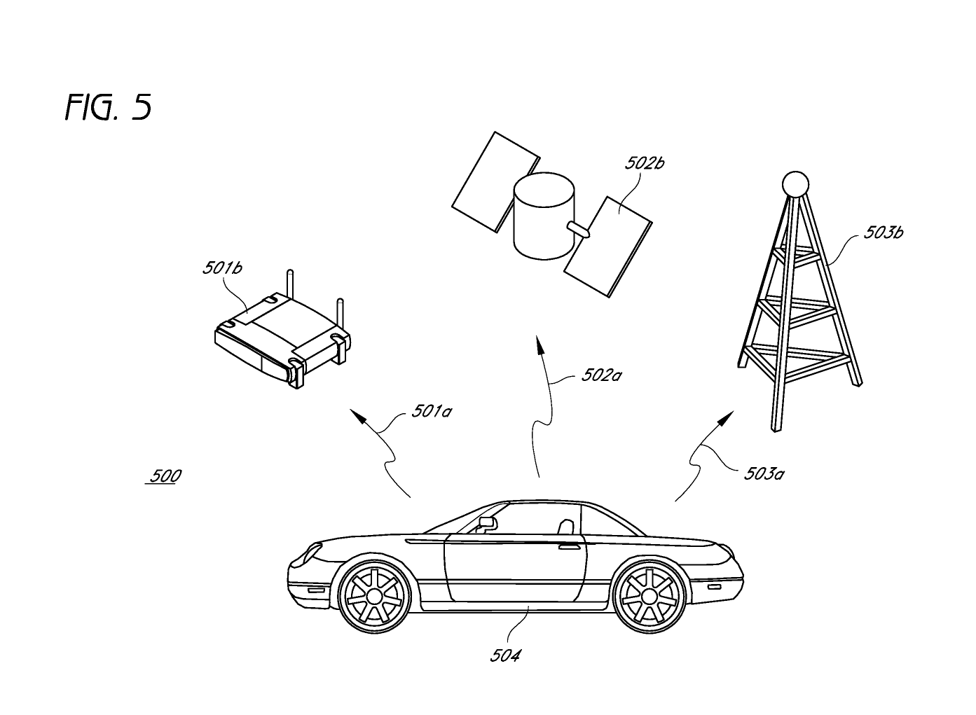

Parking-related information retrieval can be accomplished, for example, by first identifying the present location of the vehicle 101. Certain embodiments contemplate the use of vehicle-specific positioning systems, such as encoders, for verifying vehicle location. However, any suitable vehicle position system can be used such as a global positioning system (GPS), wireless location system, or Hybrid Positioning System (HPS), described in greater detail below with reference to FIG. 5. An HPS may typically provide resolution within less than 4-5 meters. Once acquired, this location information is then cross-referenced with the database 106 via communication uplink 104. Communication uplink 104 may include, for example, a wide-area-network (WAN) as a general-purpose wireless internet connection. Database 106 may timestamp the incoming request, and use the timestamp in conjunction with the vehicle's location to identify information relevant to the vehicle's present location. After the information is retrieved, the beacon 102 may notify the handheld device 105 of the information. An associated program running on the handheld 105 or beacon 102 may then determine when and how best to present the information to the user.

Parking related information may include, for example, regulatory and historical information about a given location. Regulations may include, for example, whether and when it is permissible to park in a given location, parking fees, construction notices, street cleaning times, garbage collection, etc. Historical information may comprise, for example, a record of previous tickets given in the area, incidents of crime, and so forth. Planned events in the future, such as parades or street fairs may also be included in historical information. Parking related information therefore may include, without being limited thereto, both regulatory and non-regulatory matters.

FIG. 2 is a top-level block diagram of certain embodiments' architecture for identifying relevant parking information and notifying a handheld unit, wherein the handheld unit serves as the location beacon. Unlike the architecture of FIG. 1, a separate device serving as the beacon in the vehicle is not required and the beacon's purpose is served instead by the handheld device. Many handheld devices are capable of interfacing with both positioning systems 202 and communication uplinks 203. As in the other embodiments, communication uplinks may comprise internet connections, connections to a PSTN network, or any other means for transmitting data from and possibly to the database. As mentioned, these networks may operate a variety of communication protocols, such as WIFI, mobile telephone communications, Bluetooth, etc. In these embodiments the software program notifying the user may be the same as that which identifies the position and communicates with the database 205, but this need not be the case.

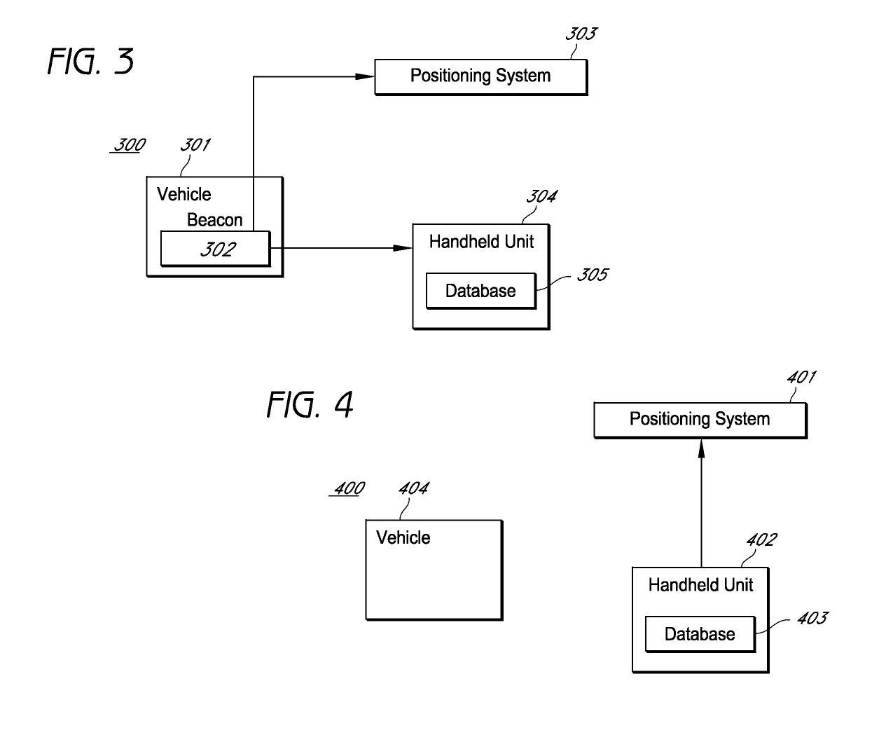

FIG. 3 is a top-level block diagram of certain embodiments' architecture for identifying relevant parking information and notifying a handheld unit wherein the database is stored locally to the handheld. In this embodiment, the handheld unit 304 no longer serves as the beacon 302, but instead includes the locally stored database 305. Locally stored database 305 may be periodically updated, for example, by a remote server, as in FIGS. 1 and 2, but can provide the added benefit of immediate database consultation by the handheld device without first locating a communication uplink. During communication outages, this design can be particularly helpful, which may frequently be the case in rural or underdeveloped locations. Naturally, variations on each of these designs are possible, such as when a portion of a remote database is cached locally on the handheld device or beacon. In some aspects, the systems and devices can be able to operate under either or both configurations. In other words, in some aspects the handheld unit 301 can include the database 305 and also communicate with a database when an uplink or communication link is available.

FIG. 4 is a top-level block diagram of certain embodiments' architecture for identifying relevant parking information and notifying a handheld unit wherein the database is stored locally to the handheld, and the handheld additionally serves as the beacon. In these embodiments, the handheld unit may function as the beacon and may maintain a local database. The particular embodiments implementing this architecture may be easily deployed, for example in a single software program downloaded onto the handheld device 402. As noted above, in some aspects, the systems and devices may operate under either or both configurations. In other words, in some aspects the handheld unit can include the database 403 and also communicate with a database when an uplink or communication link is available. As has been mentioned, it will be readily understood that FIGS. 1-4 represent a variety of possible architectures, and variations in their structure, including additions and deletions of their various components may be made.

FIG. 5 is a schematic diagram of the possible communication mechanisms available to a hybrid positioning system (HPS). A hybrid positioning system, such as the Skyhook® Wireless XPS system, integrates various complementary telecommunications systems to identify a user's location. In certain embodiments, the complementary systems may include, for example, Wi-Fi 501b, global positioning systems 502b, and cellular network triangulations 503b. Additional systems, such as IP address cross-referencing may also be used to acquire positioning information of various granularities. Some embodiments consider using these telecommunications systems individually to determine location, rather than together as part of a hybrid system. For example, positioning information may be acquired by using a GPS, Wi-Fi or triangulation system in isolation.

GPS and Wi-Fi systems frequently provide complementary coverage. For example, Global Positioning Systems work extremely well in open areas, with few obstructions, while Wi-Fi generally performs better in dense indoor environments. GPS can fail in these latter environments due to poor line-of-sight and reflectance based distortion. Additionally, GPS configuration acting alone typically requires a setup time on the order of minutes, whereas Wi-Fi can serve to provide a preliminary location estimate used to more quickly configure the GPS system. Thus, multiple complementary connections 501a-503a may be maintained simultaneously.

Certain embodiments contemplate maintaining a Wi-Fi database of all the active hot spots in a given area. In some embodiments, the handheld unit or beacon can facilitate the maintenance of this database by providing updated information regarding hotspots encountered while the vehicle is in transit. Particular systems such as Skyhook Wireless XPS may be used, for example. In some embodiments the reference database may be part of the database containing the parking-related information.

In addition to Wi-Fi, GPS, and IP address location systems, hybrid positioning may also take advantage of cellular tower triangulation. This technique involves querying a plurality of three or more towers for their location and then measuring the time delay until a response is received from each. Based on the delays, the present location can be inferred relative to the three towers, and a global position inferred based on the location information of the three towers themselves. Like Wi-Fi, this limited information can improve the configuration/acquisition time for GPS systems by providing a gross estimate of the present location. Once location information has been acquired, either by the beacon or handheld device, it may be cached for subsequent approximations or use locally on either device immediately. While certain particular systems and methods for determining position have been described, it should be noted and understood that any positioning device, system, or module can be used. At its simplest, the user can even input his/her location into the device or system.

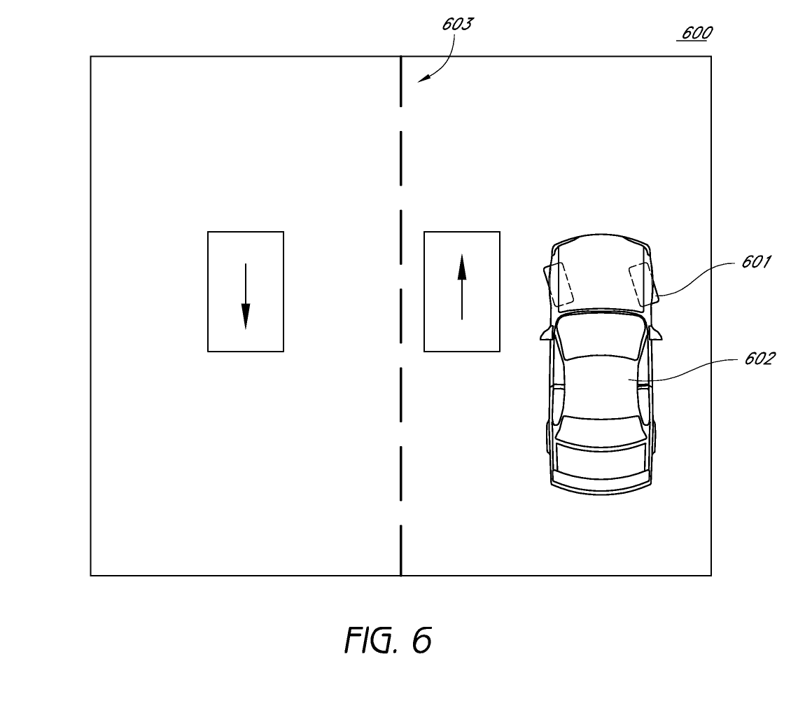

In addition to regulatory and historical information about a position, some embodiments also contemplate the handheld unit providing the user with information, such as “suggestions” and “tips” based on their parking location. FIG. 6, for example, is a schematic diagram of one example of a layout for depicting parking-related suggestions. In this example, the display 600 indicates that the user 602 has parked at the shoulder of road 603. Recognizing that the road is on an incline, it would be beneficial for the user to rotate the vehicle's wheels 601 to avoid rolling into the street should the parking brake fail. The system thus presents the user with this notification at an optimal time, i.e., after coming to a complete stop but before the user has had time to exit the vehicle. Parking beside a fire-hydrant or mailbox may also be similarly indicated to alert the user to a possible violation or a more optimal parking location. Certain embodiments contemplate incorporating a gyroscopic sensor or an accelerometer into the beacon or handheld device to facilitate identification of the vehicle position and orientation (such as parked on an incline). In some embodiments, the information or position and/or orientation can be stored on a database so that it can be communicated to the user.

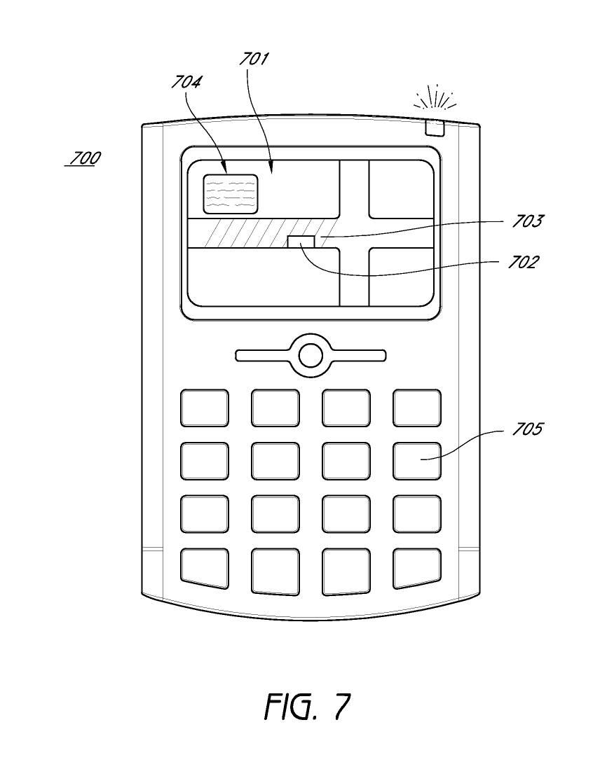

FIG. 7 is a schematic diagram of a non-limiting example of a handheld device and the user interface of one non-limiting example of an embodiment. In certain embodiments, the system can display a map 701 of the local streets and identify the vehicle's presently determined position 702. Indicia of local ordinances and parking-related information may be provided 703 and supplemental explanatory text 704 included. Ordinance and environmental indicia 703 may be shown, for example, in conjunction with a particular street. This street may be related to the user's present location, or a distant location of interest selected by the system or user (such as, e.g., a future destination). In some embodiments, the user can correct the system or provide supplemental information by indicating on the screen where they are located, or intend to park (on a handheld incorporating a touchscreen or other input mechanism, the user may simply touch or input the relevant street or address). The software permits queries of the database using the user interface 705 accompanying the device 700. The embodiment of FIG. 7 is demonstrative of the elements common to many handheld devices. One skilled in the art, in view of the disclosure, will readily recognize that touch-screen and alternative interactive displays can be utilized, and will present similar functionality albeit by a slightly different presentation (controls 705 may, for example, be incorporated into the display showing map 701). For example, the display may comprise only text, or may comprise only images. In some embodiments, parking-related information is presented to the user as a combination of text and image. Auditory alerts and vibrations of the handheld unit may also inform the user.

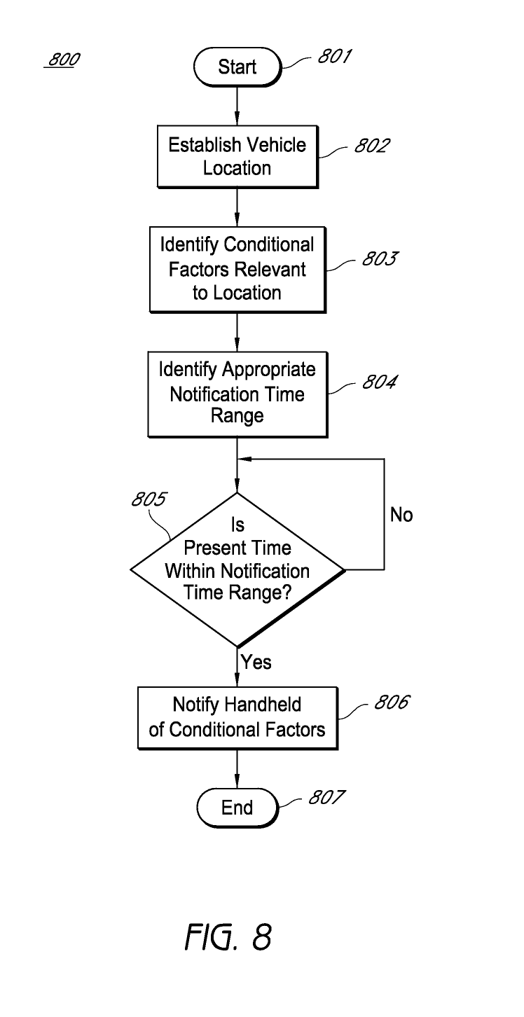

FIG. 8 is a flow diagram of one example of an embodiment of the system's operation. The system starts 801 by establishing the location of the vehicle 802 through one of the methods described herein (user input, gps, vehicle encoders, etc.), in some embodiments using either the beacon or handheld device. Once the location has been identified, the system communicates with the database, either locally or remotely, to identify conditional factors relevant to the location 803. In some embodiments, a timestamp is acquired, so that the time of parking may be employed to filter the information returned from the database. For example, a regulation that applies in the morning hours may be irrelevant to a user parking in the evening. Once the relevant information, and if applicable, the timestamp, have been acquired, the system then determines an appropriate notification time range for the user 804. An appropriate notification time range may be determined based upon a combination of the user preferences, past behavior and knowledge of the applicable parking information. For example, if a user is parking their car for the evening, a parking ordinance that takes effect in the late morning may be best presented to the user in conjunction with their morning alarm. Alternatively, if the user has a history of late rise times, they may be notified the evening in advance. By monitoring previous usage the handheld system may make a record of the optimal notification times.

Some embodiments contemplate identifying the probability that a ticket will be given in the near future (say within a half hour) and notifying the user before they travel too far from their vehicle. The probability estimate may be based upon historical data retrieved from the database—for example, the number of reported violations at the current time of day relative to the total number of violations. Alternatively, the probability may simply rise exponentially with time, or assume a poisson distribution. A standard time period for notification, such as when the user has parked in a zone that will be susceptible to ticketing within two hours, may be used to determine when to automatically alert the user.

The devices and systems can receive input from a user. For example, some embodiments contemplate permitting the user to modify and or update information in the database or notification system to provide more accurate information. For example, if the user notices conflicting data, the user can input overriding parameters and potentially an expiration date for the data in the case of a temporary situation, such as a construction zone. Furthermore, if the user determines that parking parameters are incorrect, missing, or temporarily inapplicable (construction, big event, etc.) they may personally update the system. In some embodiments, these updates may be spread to other users to facilitate a constantly updating system.

The system then takes note of the appropriate notification range and waits until the present time falls within the selected range 805. At that time the handheld unit notifies the user of the relevant parking information. Some embodiments contemplate a countdown, visually displayed to the user, should the user want to check when their vehicle would be susceptible to being ticketed. This visual indicia may be in the form of, for example, email, text messages, images on cell phone or mobile device displays, and/or notifications on a TV or computer screen, or any other suitable mode of communicating the information, such as a phone call, audio message or alarm. Additionally, the mobile device may calculate the distance from the user's present location to their vehicle to additionally provide an estimate of the required time to return. This information can be incorporated into the countdown.

Some embodiments contemplate a “vacation mode” wherein a user may select an area and then receive information regarding the nearest location where a vehicle could be left for a maximum or selected period of time. While on vacation, the handheld unit may be updated to reflect changes to the parking-related information. Additionally, one skilled in the art will readily recognize that the disclosed embodiments may provide secondary functionality in addition to notification of parking-related information. For example, in some embodiments, the beacon may serve a dual purpose, not only receiving positioning information but retransmitting the position information to the handheld unit so that the vehicle may be located when it is stolen, towed, or being operated by a co-owner.

One skilled in the art will recognize in view of the disclosure that these operations may be performed on the beacon, the handheld, or a combination of the two. In certain embodiments, users may query the database via the handheld to immediately retrieve information for their present or a proposed parking location. Users may specify an area of interest and request suitable parking locations based on the activity to be performed in that area (for example, collecting groceries, unloading luggage, and so forth).

The techniques described in this disclosure may be implemented in hardware, software, firmware, or any combination thereof. Any features described as units or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Depiction of different features as units is intended to highlight different functional aspects of the devices illustrated and does not necessarily imply that such units must be realized by separate hardware or software components. Rather, functionality associated with one or more units may be integrated within common or separate hardware or software components. Reference to such terms as “module” or “component” will be understood to refer to either hardware, software, or a combination of both for performing a given function.

The foregoing description details certain embodiments of the devices and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Various embodiments of this disclosure have been described. These and other embodiments are within the scope of the following claims.

What is claimed is:

1. A non-transitory computer-readable medium comprising instructions configured to cause a computer to perform the following operations:
recording a vehicle position based on at least a hybrid positioning system;
selecting a plurality of conditions based on regulations and historical information associated with receipt of a parking ticket, the information retrieved from a database on a remote server;
monitoring the plurality of conditions with reference to the vehicle position and to a database of ordinances;
determining the satisfaction of one or more of the plurality of conditions;
determining a time to notify a user of satisfaction of at least one of the conditions; and
notifying the user of the satisfaction of at least one of the conditions via at least one of visual or auditory indicia at the determined time.

2. A computer-implemented system for parking notification executed on at least one processor, the system comprising:
a positioning module configured to determine position coordinates;
a handheld notification module configured to alert the user upon satisfaction of at least one condition;
wherein at least one of said positioning module and said handheld notification module is configured to receive parking information from a database.

3. The system of claim 1, wherein the positioning module comprises part of a beacon.

4. The system of claim 3, wherein the beacon is located in a vehicle.

5. The system of claim 4, wherein the beacon is powered by the vehicle's battery.

6. The system of claim 1, wherein the positioning module and handheld notification module comprise parts of a handheld device.

7. The system of claim 1, wherein the position coordinates are derived from at least one of a GPS system, an encoder in the vehicle, and a manual input by a user.

8. The system of claim 1, wherein the database is located on the same device as at least one of the handheld notification module and the positioning module.

9. The system of claim 1, wherein the database is located on a remote server.

10. The system of claim 9, wherein the handheld module communicates with the database via a wireless protocol to determine a condition's satisfaction.

11. The system of claim 1, wherein position coordinates determined from the positioning module are used to notify the handheld module of a condition's satisfaction.

12. The system of claim 1, wherein said parking information comprises the frequency of crime within a range of the position coordinates.

13. The system of claim 1, wherein the condition comprises the time remaining on at least one of a parking permit or a parking meter.

14. The system of claim 1, wherein the handheld module is configured to receive the amount of money provided to a parking meter, and the condition comprises the time remaining until expiration based on the amount.

15. The system of claim 1, wherein the positioning module is located within the handheld notification module.

16. The system of claim 15, wherein the notification module receives a user notification of the parking location.

17. The system of claim 1, wherein the handheld module comprises part of a cellular phone.

18. A computer-implemented system for parking notification executed on at least one processor, the system comprising:
means for determining a position comprising position coordinates;
means for handheld notification configured to alert a user upon satisfaction of at least one condition, said handheld notification means comprising a visual display depicting a map of the vehicle's present location and one or more relevant ordinances;
wherein at least one of said determining a position means and said handheld notification means is configured to receive parking information from a database relevant to said position coordinates.

19. The computer-implemented system of claim 18, wherein the determining a position means comprises a positioning module and the handheld notification means comprises a handheld notification module.

20. A non-transitory computer-readable medium comprising instructions configured to cause a computer to perform the following operations:
recording a vehicle position;
selecting a plurality of conditions;
monitoring the plurality of conditions via a handheld device with reference to the positioning module and to a database of ordinances;
notifying a user of the handheld device upon satisfaction of one or more of the plurality of conditions, via at least one of visual or auditory indicia.

21. The computer-readable medium of claim 20, wherein the plurality of conditions of interest are selected via the handheld device.

22. The computer-readable medium of claim 20, wherein recording the vehicle position comprises generating a timestamp, said timestamp subsequently used in the determination of at least one of the plurality of conditions' satisfaction.

23. A method for providing information associated with a parked vehicle, performed on one or more computer processors, comprising:
determining a vehicle's location;
communicating the location via a wireless device to a database on a remote server; and
receiving parking information from the database associated with the location.

24. The device of claim 23, wherein determining a vehicle's location comprises waiting for the vehicle's engine to be stopped.
